(19) United States
(12) Patent Application Publication
(10) Pub. No.: US 2022/0263553 A1
(43) Pub. Date: Aug. 18, 2022

(54) PHYSICAL DOWNLINK SHARED CHANNEL (PDSCH) POWER BACKOFF IN ACTIVE ANTENNA SYSTEMS (AAS)

(71) Applicant: Telefonaktiebolaget LM Ericsson (publ), Stockholm (SE)

(72) Inventors: Yongquan QIANG, Ottawa (CA); Hong REN, Kanata (CA); Jianguo LONG, Kanata (CA); Shiguang GUO, Kanata (CA)

(21) Appl. No.: 17/621,831

(22) PCT Filed: Jun. 25, 2019
(86) PCT No.: PCT/IB2019/055356

§ 371 Date: Dec. 22, 2021

(51) Int. Cl. H04B 7/06; H04W 52/36

(52) U.S. Cl. CPC H04B 7/0617; H04W 52/367; H04W 52/365; H04B 7/0626

(57) ABSTRACT

A method, network node and wireless device to apply power backoff to the physical downlink shared channel (PDSCH) based at least in part on a power backoff value are provided. According to one aspect, a method in a wireless device (WD) includes determining a beamforming gain based at least in part on a difference 5 between a physical downlink shared channel, Determine A Beamforming Gain Of A Physical Downlink PDSCH, received power and a reference signal received power. The method also includes transmitting the determined beamforming gain to a network node. 10 1008949

### TECHNICAL FIELD

This disclosure relates to wireless communication and in particular to physical downlink shared channel (PDSCH) power backoff in active antenna systems (AAS).

### BACKGROUND

Active antenna systems (AAS) are one of the technologies adopted by the Third Generation Partnership Project (3GPP) in the Fourth Generation (4G) wireless communication standards to enhance the wireless network performance and capacity of the network. This enhancement is achieved by, for example, using full dimension multiple input multiple output (FD-MIMO) or massive MIMO. A typical AAS system includes a two-dimensional antenna elements array with M rows, N columns and K polarizations (K=2 in case of cross-polarization) as shown in FIG. 1.

Codebook-based precoding in an AAS is based on a set of pre-defined precoding matrices. The precoding matrix indication (PMI) may be selected by a wireless device (WD) with downlink (DL) channel state information reference signals (CSI-RS), or by a base station (e.g., eNB/gNB) with uplink (UL) reference signals. An eNB is a Long Term Evolution (LTE) base station, and a gNB is a New Radio (NR) (NR is also referred to as “5G”) base station.

The precoding matrix, denoted as W, may be described as, for example, a two-stage precoding structure as follows:

W=W₁W₂ (1)

The first stage of the precoding structure, i.e., W₁, may be described as a codebook, and consists essentially of a two dimensional grid-of-beams (GoB), which may be characterized as

$${W}_{1} = [ \begin{matrix}{w}_{h} ⊗ {w}_{v} & 0 \\ 0 & {w}_{h} ⊗ {w}_{v}\end{matrix} ] .$$

The terms wₕ and wᵥ are precoding vectors selected from an over-sampled discrete Fourier transform (DFT) for the horizontal direction and vertical direction, respectively, and may be expressed by

$${w}_{h} = {\frac{1}{\sqrt{N}} [ 1 , {e}^{\frac{j 2 π h}{N {O}_{1}}} , … , {e}^{\frac{j 2 π n v}{N {O}_{1}}} , … , {e}^{\frac{j 2 π ( N - 1 ) h}{N {O}_{1}}} ]}^{T} \\ {w}_{v} = {\frac{1}{\sqrt{M}} [ 1 , {e}^{\frac{j 2 π v}{M {O}_{2}}} , … , {e}^{\frac{j 2 π m v}{M {O}_{2}}} , … , {e}^{\frac{j 2 π ( M - 1 ) v}{M {O}_{2}}} ]}^{T}$$

where O₁ and O₂ are the over-sampling rate in horizontal and vertical directions, respectively.

The second stage of the precoding matrix, i.e., W₂, is used for beam selection within the group of 2D grids of beams (GoB) as well as the associated co-phasing between two polarizations.

Traditionally, the physical downlink shared channel (PDSCH) is transmitted with a fixed power by normalizing PDSCH energy per resource element (EPRE) to a given ratio of common reference signals, such as e.g., a cell specific reference signal (CRS) in Long Term Evolution (LTE), or non-beamformed CSI-RS and total radiated sensitivity (TRS) in NR. Such normalized EPRE may be configured as nomPDSCH-RS-EPRE-Offset in LTE, and powerControlOffset in NR. The PDSCH EPRE may be irrelevant to beamforming gain. In AAS, on one hand, high beamforming gain (e.g., 18 dB with 64 transmitters) on the PDSCH is likely observed by the WD from WD-specific beamforming.

On the other hand, the common reference signals are usually broadcast without beamforming gain. As a result, the power level on PDSCH resource elements (REs) observed by the WD is much higher than the power level on non-beamformed reference signals. Ideally, there is no negative impact due to the orthogonality between PDSCH REs and non-beamformed reference signals. However, due to radio frequency (RF) non-linearity or phase noise, the orthogonality between PDSCH REs and non-beamformed reference signals is distorted, which causes non-beamformed signals to suffer leakage/interference from PDSCH REs, as shown in FIG. 2.

In FIG. 2, parameter A represents the CRS signal to interference plus noise ratio (SINR) when the PDSCH is off, parameter B represents the CRS SINR when the PDSCH is on, and parameter C represents the beamforming gain. When the PDSCH is off, the CRS SINR (CRS power level—Noise and interference floor) is high. However, when the PDSCH on, the power level on the PDSCH is much higher than that of CRS due to the beamforming gain, so that the leakage from the PDSCH becomes a dominant interference with the CRS. This interference causes the degradation of CRS SINR and corresponding CSI accuracy including channel quality index (CQI)/precoding matrix indicator (PMI)/rank indicator (RI).

Some problems may be caused by fixed PDSCH power transmission in case of high beamforming gain.

### Incorrect CQI and Rank Report

In LTE with transmission mode (TM8), the WD reports CQI and rank based on CRS SINR without beamforming considered. According to FIG. 2, the CQI reported when the PDSCH is on would be lower than that when the PDSCH is off. As a result, the rank report is also conservative when the PDSCH is on.

In NR with “Type-I” codebook precoding, the WD reports CQI and rank based on the CSI-RS SINR plus beamforming gain with associated PMI. When the PDSCH is off, the CQI would be much higher than that when the PDSCH is on. As a result, the rank report is aggressive when the PDSCH is off.

For bursty traffic using PDSCH dynamic on/off, the CQI and rank report in both LTE and NR would be incorrect if there is fluctuation.

### Incorrect PMI Report

In NR with “Type-I” codebook, the WD reports the PMI based on beam measurement on CSI-RS. With the PDSCH on and with high beamforming gain, CSI-RS quality is degraded, which might cause an incorrect PMI report.

### Inaccurate Timing and Frequency Tracking

In NR, the TRS is used for timing and frequency tracking. With PDSCH leakage, the signal quality of TRS becomes poor, which might cause inaccurate timing and frequency offset estimation.

### Interference to Neighboring Cells

High beamforming gain helps to increase signal power. On the other hand, high beamforming gain causes more interference with neighboring cells if extra power is used for transmission when peak throughput is achieved.

### Power Waste and Unnecessary RF Exposure

Extra power being used for transmission when peak throughput is achieved is not efficient power transmission, but rather wastes energy. Furthermore, extra power used for transmission causes unnecessary RF exposure which might not comply with RF exposure requirements.

### SUMMARY

Some embodiments advantageously provide a method, network node and wireless device for performing PDSCH power backoff dynamically based on beamforming gain in AAS. According to one aspect, a network node is configured to obtain beamforming gain of the PDSCH over non-beamformed reference signals and/or over beamformed PDSCH SINR and to determine a PDSCH power backoff value (PBV) according to predefined targets. The network node is further configured to perform PDSCH power backoff by applying the PBV on link adaptation and beamforming weights. The beamforming gain may be obtained by a report from the WD or estimated at the network node by using an uplink reference signal. The predefined targets may include:
Maximum PDSCH SINR
Maximum beamforming gain
Maximum PDSCH SINR and maximum beamforming gain
Maximum PDSCH SINR and minimum beamforming gain
Maximum PDSCH SINR and maximum beamforming gain and minimum beamforming gain

According to another aspect, the WD measures a beamforming gain and reports the measured beamforming gain to the network node, and further reports to the network node the WD's maximum beamforming gain capability.

According to one aspect, a network node includes processing circuitry configured to determine a beamforming gain of a physical downlink shared channel, PDSCH, determine a PDSCH power backoff value, PBV, according to at least one predefined target and apply power backoff to the PDSCH based at least in part on the PBV.

According to this aspect, in some embodiments, the determined beamforming gain is a gain of PDSCH resource element power over a non-beamformed cell-specific reference signal, CRS, or channel state information reference signal, CSI-RS. In some embodiments, the determined beamforming gain is included in a beamformed PDSCH signal to interference plus noise ratio, SINR. In some embodiments, the PDSCH SINR is estimated from a, cell specific reference signal, CRS, or channel state information reference signal, CSI-RS, received by the WD. In some embodiments, the at least one predefined target includes at least one of a maximum PDSCH SINR and a maximum beamforming gain. In some embodiments, the determined beamforming gain is an estimation of beamforming gain received from the WD. In some embodiments, the estimated beamforming gain received from the WD is received as one of channel state information fields. In some embodiments, the determined beamforming gain is estimated by the network node. In some embodiments, the determined beamforming gain is determined as a difference between a power of a strongest received WD-specific beam and a power of a received common beam. In some embodiments, applying power backoff is performed on PDSCH by both link adaptation and beamforming weight adjustment.

According to another aspect, a method in a network node is provided. The method includes determining a beamforming gain of a physical downlink shared channel, PDSCH, determining a PDSCH power backoff value, PBV, according to at least one predefined target, and applying power backoff to the PDSCH based at least in part on the PBV.

According to this aspect, in some embodiments, the determined beamforming gain is a gain of PDSCH resource element power over a non-beamformed cell- specific reference signal, CRS, or a channel state information reference signal, CSI-RS. In some embodiments, the determined beamforming gain is included in a beamformed PDSCH signal to interference plus noise ratio, SINR. In some embodiments, the PDSCH SINR is estimated from a cell specific reference, CSR, or channel state information reference signal received from the WD. In some embodiments, the at least one predefined target includes at least one of a maximum PDSCH SINR and a maximum beamforming gain. In some embodiments, the determined beamforming gain is an estimate of beamforming gain received from the WD. In some embodiments, the estimated beamforming gain received from the WD is received in a channel state information field. In some embodiments, the determined beamforming gain is a measure of beamforming gain performed by the network node. In some embodiments, the determined beamforming gain is determined as a difference between a power of a strongest received WD-specific beam and a power of a received common beam. In some embodiments, applying power backoff is performed by one of link adaptation and beamforming weight adjustment.

According to another aspect, a WD includes processing circuitry configured to determine a beamforming gain based at least in part on a difference between a physical downlink shared channel, PDSCH, received power and a reference signal received power, and transmit the determined beamforming gain to a network node.

According to this aspect, in some embodiments, the processing circuitry is further configured to determine a maximum beamforming gain based on a maximum PDSCH received power and to transmit the maximum beamforming gain to the network node.

According to yet another aspect, a method in a WD is provided. The method includes determining a beamforming gain based at least in part on a difference between a physical downlink shared channel, PDSCH, received power and a reference signal received power and transmitting the determined beamforming gain to a network node.

According to this aspect, the method further includes determining a maximum beamforming gain based on a maximum PDSCH received power and to transmit the maximum beamforming gain to the network node.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates and array of cross-polarized antenna elements;

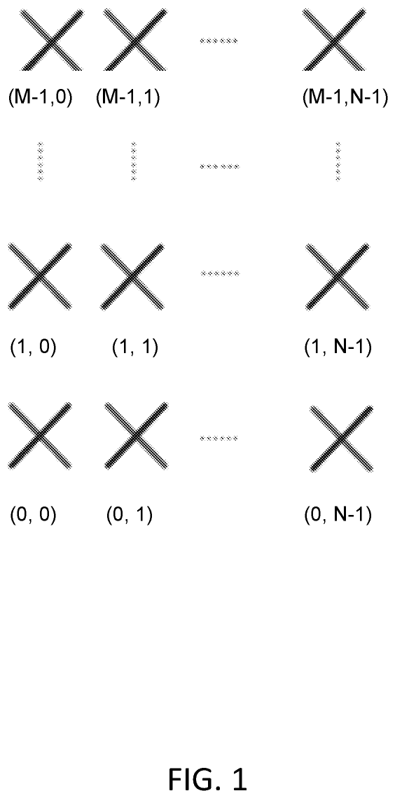

FIG. 2 is a bar graph comparing PDSCH power and CRS power;

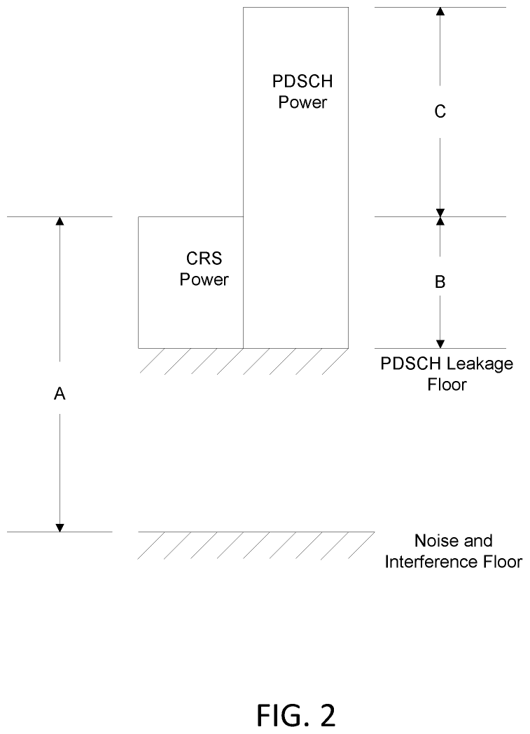

FIG. 3 is a schematic diagram of an exemplary network architecture illustrating a communication system according to the principles of the present disclosure;

FIG. 4 is a block diagram of a network node in communication with a wireless device over a wireless connection according to some embodiments of the present disclosure;

FIG. 5 is a flowchart of an exemplary process in a network node according to some embodiments of the present disclosure;

FIG. 6 is a flowchart of an exemplary process in a wireless device according to some embodiments of the present disclosure;

### DETAILED DESCRIPTION

Before describing in detail exemplary embodiments, it is noted that the embodiments reside primarily in combinations of apparatus components and processing steps related to physical downlink shared channel (PDSCH) power backoff in active antenna systems (AAS). Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In some embodiments, a network node is configured to obtain beamforming gain of the PDSCH over non-beamformed reference signals and/or over beamformed PDSCH SINR and to determine a PDSCH power backoff value (PBV) according to predefined targets. The network node is further configured to perform PDSCH power backoff by applying the PBV on link adaptation and beamforming weights. The beamforming gain may be obtained by a report from the WD or estimated at the network node by using an uplink reference signal. Some embodiments enhance network node beamforming performance by mitigating the PDSCH leakage to un-beamformed reference signals and interference to neighboring cells. Some embodiments enhance WD ability to perform timing and frequency tracking and to report more reliable CSI. Also, some embodiments save power consumption and reduce unnecessary power emissions by the network node.

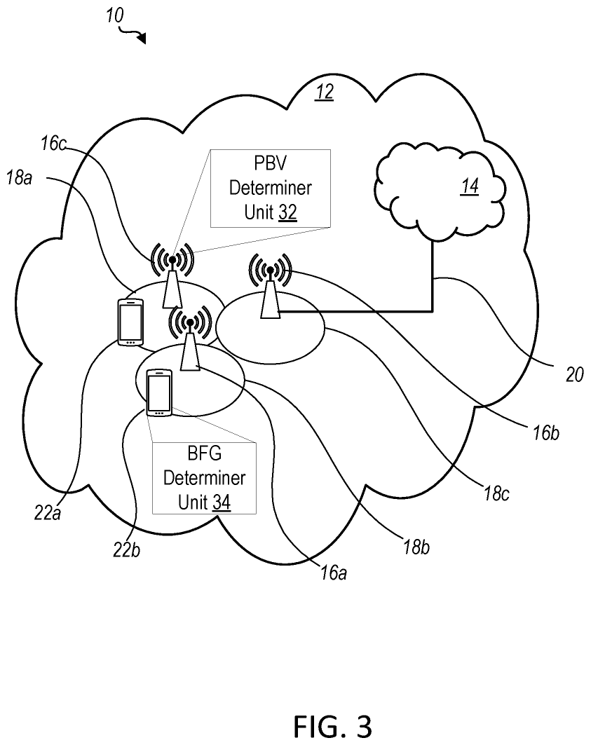

Returning now to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 is configured to include a power backoff value determiner unit 32 which is configured to determine a PDSCH power backoff value as described in detail herein. A wireless device 22 is configured to include a beamforming gain determiner unit 34 which is configured to determine a beamforming gain of a PDSCH as described in detail herein.

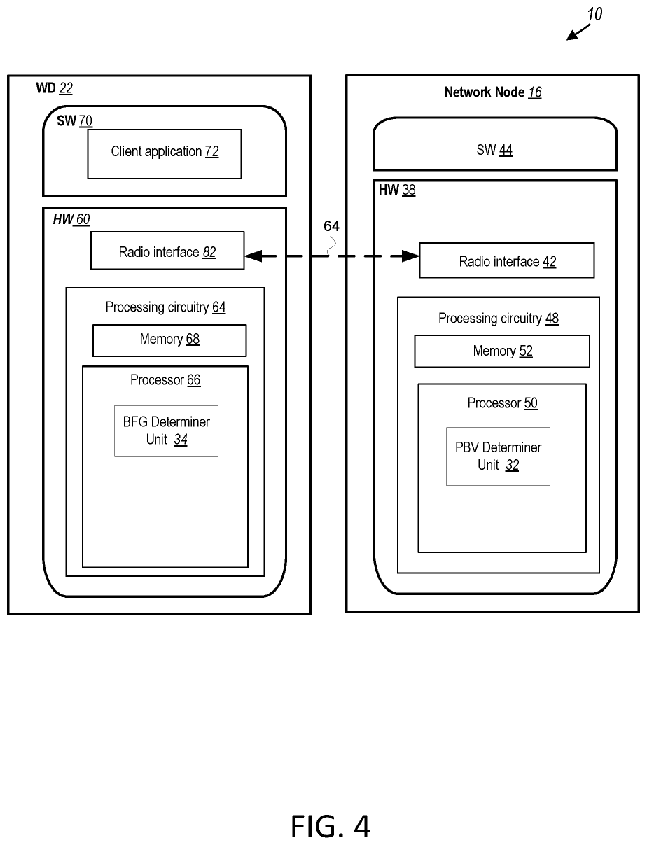

Example implementations, in accordance with an embodiment, of the WD 22, network node 16 and host computer 24 discussed in the preceding paragraphs will now be described with reference to FIG. 4.

The communication system 10 includes a network node 16 provided in a communication system 10 and including hardware 38 enabling the network node 16 to communicate with the WD 22. The hardware 38 may include a radio interface 42 for setting up and maintaining at least a wireless connection 46 with a WD 22 located in a coverage area 18 served by the network node 16. The radio interface 42 may be formed as or may include, for example, one or more RF transmitters, one or more RF receivers, and/or one or more RF transceivers.

In the embodiment shown, the hardware 38 of the network node 16 further includes processing circuitry 48. The processing circuitry 48 may include a processor 50 and a memory 52. In particular, in addition to or instead of a processor, such as a central processing unit, and memory, the processing circuitry 48 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 50 may be configured to access (e.g., write to and/or read from) the memory 52, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 44 stored internally in, for example, memory 52, or stored in external memory (e.g., database, storage array, network storage device, etc.) accessible by the network node 16 via an external connection. The software 44 may be executable by the processing circuitry 48. The processing circuitry 48 may be configured to control any of the methods and/or processes described herein and/or to cause such methods, and/or processes to be performed, e.g., by network node 16. Processor 50 corresponds to one or more processors 50 for performing network node 16 functions described herein. The memory 52 is configured to store data, programmatic software code and/or other information described herein. In some embodiments, the software 44 may include instructions that, when executed by the processor 50 and/or processing circuitry 48, causes the processor 50 and/or processing circuitry 48 to perform the processes described herein with respect to network node 16. For example, processing circuitry 48 of the network node 16 may include PBV determiner unit 32 configured to determine a PDSCH power backoff value.

The communication system 10 further includes the WD 22 already referred to. The WD 22 may have hardware 60 that may include a radio interface 62 configured to set up and maintain a wireless connection 64 with a network node 16 serving a coverage area 18 in which the WD 22 is currently located. The radio interface 62 may be formed as or may include, for example, one or more RF transmitters, one or more RF receivers, and/or one or more RF transceivers.

The hardware 60 of the WD 22 further includes processing circuitry 64. The processing circuitry 64 may include a processor 66 and memory 68. In particular, in addition to or instead of a processor, such as a central processing unit, and memory, the processing circuitry 64 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 66 may be configured to access (e.g., write to and/or read from) memory 68, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 70, which is stored in, for example, memory 68 at the WD 22, or stored in external memory (e.g., database, storage array, network storage device, etc.) accessible by the WD 22. The software 70 may be executable by the processing circuitry 64. The software 70 may include a client application 72. The client application 72 may be operable to provide a service to a human or non-human user via the WD 22.

The processing circuitry 64 may be configured to control any of the methods and/or processes described herein and/or to cause such methods, and/or processes to be performed, e.g., by WD 22. The processor 66 corresponds to one or more processors 66 for performing WD 22 functions described herein. The WD 22 includes memory 68 that is configured to store data, programmatic software code and/or other information described herein. In some embodiments, the software 70 and/or the client application 72 may include instructions that, when executed by the processor 66 and/or processing circuitry 64, causes the processor 66 and/or processing circuitry 64 to perform the processes described herein with respect to WD 22. For example, the processing circuitry 64 of the wireless device 22 may include a beamforming gain unit 34 configured to include a beamforming gain determiner unit 34 which is configured to determine a beamforming gain of a PDSCH.

In some embodiments, the inner workings of the network node 16 and WD 22 may be as shown in FIG. 4 and independently, the surrounding network topology may be that of FIG. 3.

The wireless connection 46 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 3 and 4 show various “units” such as PBV determiner unit 32, and beamforming gain determiner unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

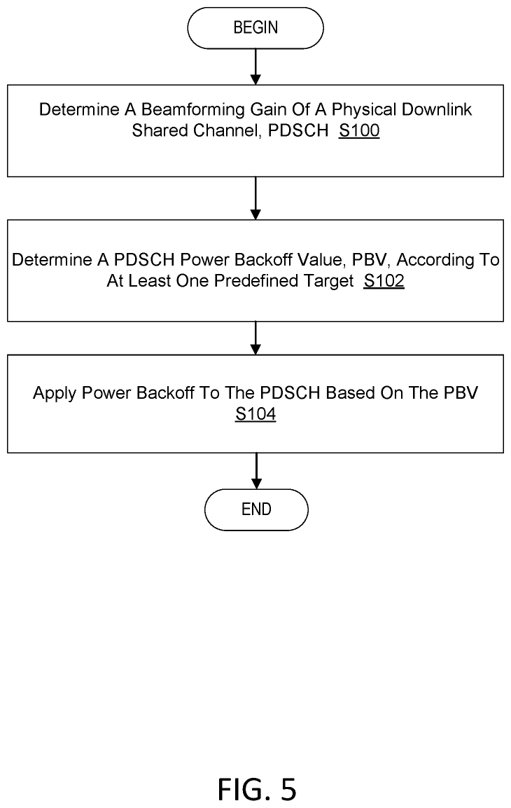

FIG. 5 is a flowchart of an exemplary process in a network node 16 according to some embodiments of the present disclosure. One or more blocks described herein may be performed by one or more elements of network node 16 such as by one or more of processing circuitry 48 (including the PBV determiner unit 32), processor 50, and/or radio interface 42. Network node 16 such as via processing circuitry 48 and/or processor 50 and/or radio interface 42 is configured to determine a beamforming gain of a physical downlink shared channel, PDSCH (Block S100). The process also includes determining a PDSCH power backoff value, PBV, according to at least one predefined target (Block S102). The process further includes applying power backoff to the PDSCH based at least in part on the PBV (Block S104).

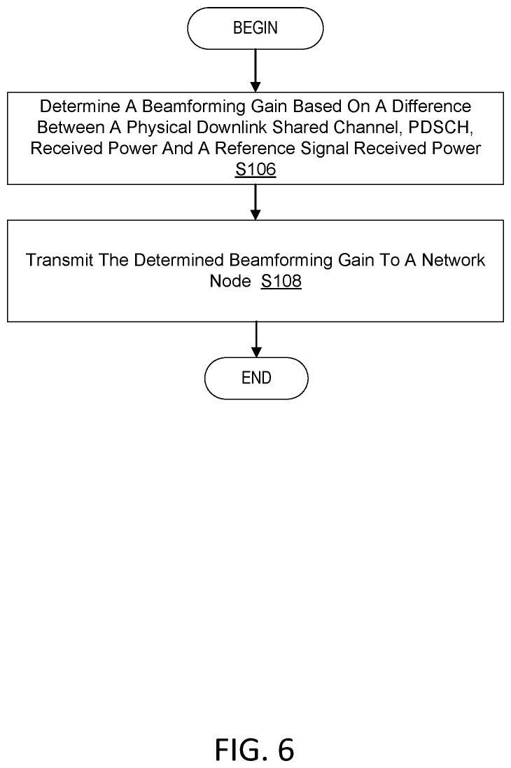

FIG. 6 is a flowchart of an exemplary process in a wireless device 22 according to some embodiments of the present disclosure. One or more blocks described herein may be performed by one or more elements of wireless device 22 such as by one or more of processing circuitry 64 (including the BFG determiner unit 34), processor 66 and/or radio interface 82. Wireless device 22 such as via processing circuitry 64 and/or processor 66 and/or radio interface 82 is configured to determine a beamforming gain based at least in part on a difference between a physical downlink shared channel, PDSCH, received power and a reference signal received power (Block S106). The process also includes transmitting the determined beamforming gain to a network node (Block S108).

Having described the general process flow of arrangements of the disclosure and having provided examples of hardware and software arrangements for implementing the processes and functions of the disclosure, the sections below provide details and examples of arrangements for physical downlink shared channel (PDSCH) power backoff in active antenna systems (AAS).

According to one aspect, a network node 16, such as via radio interface 42 and/or processing circuitry 48, e.g., via PBV determiner unit 32, is configured to obtain a beamforming gain of the PDSCH over non-beamformed reference signals and/or over beamformed PDSCH SINR, and to determine a PDSCH power backoff value (PBV) according to predefined targets. The network node 16 is further configured to perform, such as via the processing circuitry 48, PDSCH power backoff by applying the PBV on link adaptation and beamforming weights. The beamforming gain may be obtained by a report from the WD 22 or estimated at the network node 16, such as via the processing circuitry 48, by using an uplink reference signal. The predefined targets may include:
Maximum PDSCH SINR
Maximum beamforming gain
Maximum PDSCH SINR and maximum beamforming gain
Maximum PDSCH SINR and minimum beamforming gain
Maximum PDSCH SINR and maximum beamforming gain and minimum beamforming gain

There are at least two approaches to obtain the beamforming gain. One approach is from a WD 22 report. Another approach is from a network node 16 measurement by using UL reference signals. The beamforming gain (BFG) can be estimated by the WD 22 by measuring the power difference of PDSCH resource elements (REs) and non-beamformed reference signals (e.g., CSI-RS, TRS) expressed by:

BFG=Power of PDSCH REs−power of reference signals.

The measured and quantified beamforming gain (BFG) can be reported explicitly to the network node 16 by introducing a new field in a CSI report together with

PMI/CQI and rank report. The BFG can be estimated at the network node 16 by measuring, such as via the processing circuitry 48 and/or radio interface 42, the power difference between a WD-specific beam and a common beam with UL reference signals, expressed by:

BFG=Power of strongest WD-specific beam−power of a common beam

The power of the common beam is the beam power estimated at the network node 16 with DL common beamforming weight.

In Long Term Evolution (LTE), the beamformed PDSCH SINR can be estimated by the WD 22, such as via the processing circuitry 64, reported CRS SINR derived from CQI plus the BF gain, expressed by

PDSCH_SINR=CQI_SINR−2*nomPDSCH-RS-EPRE-Offset+BFG+OLA

where:
BFG—Beamforming gain in dB obtained from the WD 22 report or by network node measurement.
CQI_SINR—SINR in dB on common reference signals derived from the WD 22 CQI report
PDSCH_SINR—Beamformed PDSCH SINR in dB
OLA—Outer-loop adjustment of PDSCH link adaptation
nomPDSCH-RS-EPRE-Offset—Configured ratio of PDSCH EPRE to cell-specific reference signal (CRS) EPRE. Actual value=IE value*2 [dB].

In NR, the beamforming gain is included in the CQI reported by the WD 22. The PDSCH SINR can be derived, such as via the processing circuitry 48, from the WD 22 CQI report plus an outer-loop adjustment of PDSCH link adaptation, expressed by.

PDSCH_SINR=CQI_SINR−powerControlOffset+OLA

Where powerControlOffset is RRC configured Power offset of PDSCH RE to NZP CSI-RS RE.

Usually, to secure the WD-reported CQI without saturation, nomPDSCH-RS-EPRE-Offset and powerControlOffset is set to a negative value.

The PDSCH power backoff value (PBV) can be determined by at least one predefined target, for example
Maximum PDSCH SINR target
Maximum Beamforming gain target
PDSCH SINR and maximum beamforming gain target
PDSCH SINR and minimum beamforming gain target
PDSCH SINR and maximum beamforming gain and minimum beamforming gain target
   These targets are explained below.

### Maximum PDSCH SINR Target

The power backoff value (PBV) can be determined, such as via the PBV determiner unit 32, according to a maximum PDSCH SINR target, expressed by

PBV=max(0,PDSCH_SINR−MAX_PDSCH_SINR_TARGET).

MAX_PDSCH_SINR_TARGET is the maximum PDSCH SINR target in dB, for which the SINR can achieve downlink (DL) peak throughput.

### Maximum Beamforming Gain Target

The power backoff value in dB can be determined, such as via the PBV determiner unit 32, according to the beamforming gain target, expressed by

PBV=max(0,BFG−MAX_BFG_TARGET)

where MAX_BFG_TARGET is a maximum beamforming gain target predefined at the network node 16. It can be determined according to maximum power emission regulation, or the WD's maximum beamforming gain capability report.

### Maximum PDSCH SINR and Maximum Beamforming Gain Target

The power backoff value can be determined, such as via the PBV determiner unit 32, according to the combination of maximum PDSCH SINR target and maximum beamforming gain target, expressed by

PBV1=max(0,PDSCH_SINR−MAX_PDSCH_SINR_TARGET)

PBV2=max(0,BFG−MAX_BFG_TARGET)

PBV=max(PBV1,PBV2)

### Maximum PDSCH SINR and Minimum Beamforming Gain Target

The power backoff value can be determined, such as via the PBV determiner unit 32, according to the combination of maximum PDSCH SINR target and minimum beamforming gain target, expressed by

PBV1=max(0,PDSCH_SINR−MAX_PDSCH_SINR_TARGET)

PBV2=max(0,BFG−MIN_BFG_TARGET)

PBV=min(PBV1,PBV2)

MIN_BFG_TARGET is a pre-defined minimum beamforming gain target (e.g., 2 dB).

### Maximum PDSCH SINR and Maximum Beamforming Gain and Minimum Beamforming Gain Target

The power backoff value can be determined, such as via the PBV determiner unit 32, according to the combination of maximum PDSCH SINR target, maximum beamforming gain target and minimum beamforming gain target, expressed by

PBV1=max(0,PDSCH_SINR−MAX_PDSCH_SINR_TARGET)

PBV2=max(0,BFG−MAX_BFG_TARGET)

PBV3=max(0,BFG_MIN_BFG_TARGET)

PBV12=max(PBV1,PBV2)

PBV=min(PBV12,PBV3)

### PDSCH LA Backoff

The PDSCH power backoff is performed, such as via processing circuitry 48 and/or radio interface 42, in LA by applying the power backoff value on beamformed PDSCH SINR without power backoff, expressed by

PDSCH_SINR_POWER_BACKOFF (dB)=PDSCH_SINR (dB)−PBV (dB)

The PDSCH SINR with power backoff is used in PDSCH link adaptation (LA).

### PDSCH Transmit Power Backoff

The PDSCH transmit power backoff is performed, such as via processing circuitry 48 and/or radio interface 42, in the physical layer by applying the power backoff value on the normalized beamforming weight per RE, expressed by

Ŵ=10^{-PBV/20}*W

where W is a beamforming weight before power backoff with normalized power. Ŵ is the beamforming weight after power backoff.

The WD 22 can determine, such as via the processing circuitry 64, the maximum beamforming gain (maximum received power difference between PDSCH REs and common reference signals) capability according to the radio frequency (RF) linearity of the WD 22. Within the beamforming gain capability, there is no significant degradation on reference signal quality, PMI/CQI/RI measurement and time/frequency tracking. The maximum beamforming gain supported by the WD 22 can be reported to the network node 16 as one of the WD's capabilities explicitly or implied by a WD category class.

Note that the PBV estimation may be performed in a baseband unit in the cloud, and the estimated PBV may be sent to the network node 16 to perform power backoff.

According to one aspect, a network node 16 includes processing circuitry 48 configured to determine a beamforming gain of a physical downlink shared channel, PDSCH, determine a PDSCH power backoff value, PBV, according to at least one predefined target and apply power backoff to the PDSCH based at least in part on the PBV.

According to this aspect, in some embodiments, the determined beamforming gain is a gain of PDSCH resource element power over a non-beamformed cell-specific reference signal, CRS, or channel state information reference signal, CSI-RS. In some embodiments, the determined beamforming gain is included in a beamformed PDSCH signal to interference plus noise ratio, SINR. In some embodiments, the PDSCH SINR is estimated from a, cell specific reference signal, CRS, or channel state information reference signal, CSI-RS, received by the WD 22. In some embodiments, the at least one predefined target includes at least one of a maximum PDSCH SINR and a maximum beamforming gain. In some embodiments, the determined beamforming gain is an estimation of the beamform received from the WD 22. In some embodiments, the estimated beamforming gain received from the WD 22 is received in a channel state information field. In some embodiments, the determined beamforming gain is estimated by the network node 16. In some embodiments, the determined beamforming gain is determined as a difference between a power of a strongest received WD-specific beam and a power of a received common beam. In some embodiments, applying power backoff is performed on PDSCH by both link adaptation and beamforming weight adjustment.

According to another aspect, a method in a network node 16 is provided. The method includes determining a beamforming gain of a physical downlink shared channel, PDSCH, determining a PDSCH power backoff value, PBV, according to at least one predefined target, and applying power backoff to the PDSCH based at least in part on the PBV.

According to this aspect, in some embodiments, the determined beamforming gain is a gain of PDSCH resource element power over a non-beamformed cell-specific reference signal, CRS, or a channel state information reference signal, CSI-RS. In some embodiments, the determined beamforming gain is included in a beamformed PDSCH signal to interference plus noise ratio, SINR. In some embodiments, the PDSCH SINR is estimated from a cell specific reference, CSR, or channel state information reference signal received from the WD 22. In some embodiments, the at least one predefined target includes at least one of a maximum PDSCH SINR and a maximum beamforming gain. In some embodiments, the determined beamforming gain is an estimate of beamforming gain received from the WD 22. In some embodiments, the estimated beamforming gain received from the WD 22 is received in a channel state information field. In some embodiments, the determined beamforming gain is a measure of beamforming gain performed by the network node 16. In some embodiments, the determined beamforming gain is determined as a difference between a power of a strongest received WD-specific beam and a power of a received common beam. In some embodiments, applying power backoff is performed by one of link adaptation and beamforming weight adjustment.

According to another aspect, a WD 22 includes processing circuitry 64 configured to determine a beamforming gain based at least in part on a difference between a physical downlink shared channel, PDSCH, received power and a reference signal received power, and transmit the determined beamforming gain to a network node 16.

According to this aspect, in some embodiments, the processing circuitry is further configured to determine a maximum beamforming gain based on a maximum PDSCH received power and to transmit the maximum beamforming gain to the network node 16.

According to yet another aspect, a method in a WD 22 is provided. The method includes determining a beamforming gain based at least in part on a difference between a physical downlink shared channel, PDSCH, received power and a reference signal received power and transmitting the determined beamforming gain to a network node 16.

According to this aspect, the method further includes determining a maximum beamforming gain based on a maximum PDSCH received power and to transmit the maximum beamforming gain to the network node 16.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The following abbreviations are explained:

| Abbreviation | Explanation |
|---|---|
| AAS | Active Antenna System |
| BBU | Baseband Unit |
| BFG | Beamforming Gain |
| CRS | Cell-specific Reference Signal |
| CSI-RS | Channel State Information Reference Signal |
| CSI | Channel State Information (e.g. PMI/CQI/RI/CRI) |
| DFT | Discrete Fourier Transform |
| DMRS | Demodulation Reference Signal |
| EPRE | Energy Per Resource Element |
| FD-MIMO | Full Dimension MIMO |
| GoB | Grid-of-beams |
| LA | Link Adaptation |
| PBV | Power Backoff Value |
| PMI | Precoding Matrix Indicator |
| REs | Resource Elements |
| RRH | Remote Radio Head |
| SRS | Sounding Reference Symbol |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising a processor configured to:
determine a beamforming gain of a physical downlink shared channel, PDSCH;
determine a PDSCH power backoff value, PBV, according to at least one predefined target; and
apply power backoff to the PDSCH based at least in part on the PBV.

2. The network node of claim 1, wherein the determined beamforming gain is a gain of PDSCH resource element power over one of a non-beamformed cell-specific reference signal, CRS, and channel state information reference signal, CSI-RS.

3. The network node of claim 1, wherein the determined beamforming gain is included in a beamformed PDSCH signal to interference plus noise ratio, SINR.

4. The network node of claim 3, wherein the PDSCH SINR is estimated from one of a, cell specific reference signal, CRS, and channel state information reference signal, CSI-RS, received by the WD.

5. The network node of claim 1, wherein the at least one predefined target includes at least one of a maximum PDSCH SINR and a maximum beamforming gain.

6. The network node of claim 1, wherein the determined beamforming gain is an estimation of beamforming gain received from the WD.

7. The network node of claim 6, wherein the estimated beamforming gain received from the WD is received in a channel state information field.

8. The network node of claim 1, wherein the determined beamforming gain is estimated by the network node.

9. The network node of claim 1, wherein the determined beamforming gain is determined as a difference between a power of a strongest received WD-specific beam and a power of a received common beam.

10. The network node of claim 1, wherein applying power backoff is performed on PDSCH by both link adaptation and beamforming weight adjustment.

11. A method in a network node configured to communicate with a wireless device, WD, the method comprising:
determining a beamforming gain of a physical downlink shared channel, PDSCH;
determining a PDSCH power backoff value, PBV, according to at least one predefined target; and
applying power backoff to the PDSCH based at least in part on the PBV.

12. The method of claim 11, wherein the determined beamforming gain is a gain of PDSCH resource element power over one of a non-beamformed cell-specific reference signal, CRS, and a channel state information reference signal, CSI-RS.

13. The method of claim 11, wherein the determined beamforming gain is included in a beamformed PDSCH signal to interference plus noise ratio, SINR.

14. The method of claim 13, wherein the PDSCH SINR is estimated from one of a cell specific reference, CSR, and channel state information reference signal received from the WD.

15. The method of claim 11, wherein the at least one predefined target includes at least one of a maximum PDSCH SINR and a maximum beamforming gain.

16. The method of claim 11, wherein the determined beamforming gain is an estimation of beamforming gain received from the WD.

17. The method of claim 16, wherein the estimated beamforming gain received from the WD is received in a channel state information field.

18. The method of claim 11, wherein the determined beamforming gain is estimated by the network node.

19. The method of claim 11, wherein the determined beamforming gain is determined as a difference between a power of a strongest received WD-specific beam and a power of a received common beam.

20. The method of claim 11, wherein applying power backoff is performed by one of link adaptation and beamforming weight adjustment.

21. A wireless device, WD, comprising processing circuitry configured to:
determine a beamforming gain based at least in part on a difference between a physical downlink shared channel, PDSCH, received power and a reference signal received power; and
transmit the determined beamforming gain to a network node.

22. The WD of claim 21, wherein the processing circuitry is further configured to determine a maximum beamforming gain based at least in part on a maximum PDSCH received power and to transmit the maximum beamforming gain to the network node.

23. A method in a wireless device, WD, the method comprising:
determining a beamforming gain based at least in part on a difference between a physical downlink shared channel, PDSCH, received power and a reference signal received power; and
transmitting the determined beamforming gain to a network node.

24. The method of claim 23, further comprising determining a maximum beamforming gain based at least in part on a maximum PDSCH received power and to transmit the maximum beamforming gain to the network node.
